(19) United States
(12) Patent Application Publication
(10) Pub. No.: US 2013/0069009 A1
(43) Pub. Date: Mar. 21, 2013

(54) Systems And Methods For Controlling The Gasification Of Hydrocarbon Feedstocks

(71) Applicant: John Abughazaleh, Sugar Land, TX (US)

(72) Inventor: John Abughazaleh, Sugar Land, TX (US)

(73) Assignee: KELLOGG BROWN & ROOT LLC, Houston, TX (US)

(21) Appl. No.: 13/235,982

(22) Filed: Sep. 19, 2011

(51) Int. Cl. C01B 3/42; C01B 3/38; B01J 7/00

(52) U.S. Cl. 252/373; 422/149

(57) ABSTRACT

Systems and methods for controlling the gasification of one or more hydrocarbon feedstocks are provided. In the method, a first oxidant can be introduced to a gasifier and a first hydrocarbon feedstock can be introduced to the gasifier downstream of the first oxidant. A second oxidant can also be introduced to the gasifier downstream of the first oxidant and the first hydrocarbon feedstock. The second oxidant can be introduced from a location that is external to the gasifier. At least a portion of the first hydrocarbon feedstock can be gasified to produce a syngas.

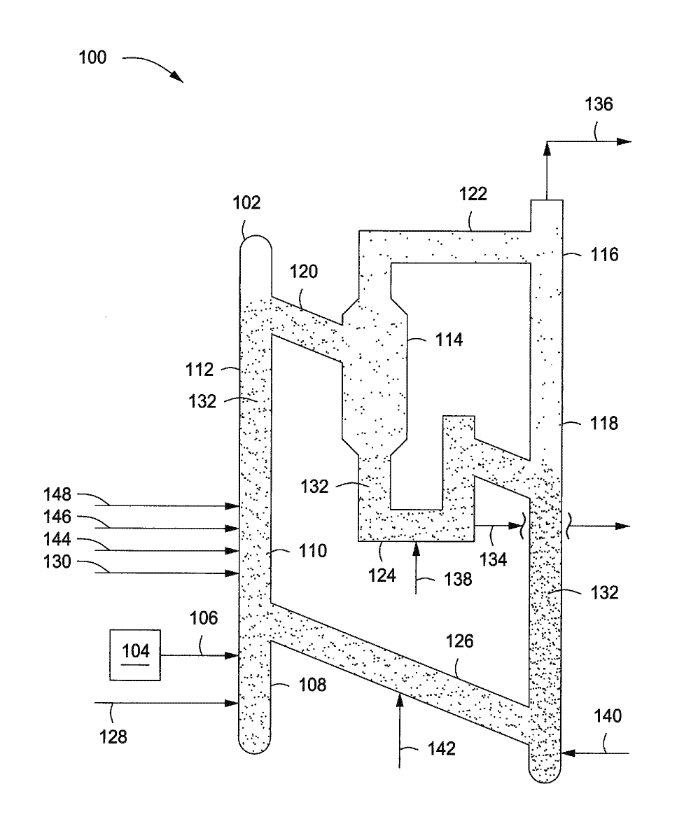

### BACKGROUND

1. Field

Embodiments described generally relate to the gasification of one or more hydrocarbon feedstocks. More particularly, such embodiments relate to controlling the gasification of one or more hydrocarbon feedstocks.

2. Description of the Related Art

Gasification is a high-temperature process usually conducted at elevated pressure to convert carbon-containing materials into carbon monoxide and hydrogen gas. Since this gas is often used for the synthesis of chemicals or synthetic hydrocarbon fuels, the gas is often referred to as “synthesis gas” or “syngas.”

Typical feeds to gasification include hydrocarbon feedstocks such as petroleum-based materials that are neat or residues of processing materials, such as heavy crude oil, coals, bitumen recovered from tar sands, kerogen from oil shale, coke, and other high-sulfur and/or high metal-containing residues; gases; and various carbonaceous waste materials. Such feedstocks can be reacted, e.g., combusted, vaporized, cracked, and/or gasified, within the gasifier in a reducing (oxygen-starved) atmosphere at high temperature and (usually) high pressure. The resulting syngas typically contains about 85 percent of the feed carbon content as carbon monoxide, with the balance being a mixture of carbon dioxide and methane.

When the hydrocarbons react within a gasifier, the heat production can create problems. For example, localized overheating can occur when the temperature of circulating particulates such as ash within the gasifier increases to the point where the particulates start to overheat, soften, and form larger particles. Such larger particles can cause a shutdown of the gasifier due to, for example, the inability to circulate the larger particles through the gasifier. The increased temperature due to the localized overheating can also damage the refractory lining within the gasifier or even damage the external walls of the gasifier.

There is a need, therefore, for improved systems and methods for controlling the gasification of hydrocarbon feedstocks.

### BRIEF DESCRIPTION OF THE DRAWINGS

The FIGURE depicts an illustrative gasification system for gasifying one or more hydrocarbon feedstocks, according to one or more embodiments described.

### DETAILED DESCRIPTION

Systems and methods for controlling the gasification of one or more hydrocarbon feedstocks are provided. In the method, a first oxidant can be introduced to a gasifier and a first hydrocarbon feedstock can be introduced to the gasifier downstream of the first oxidant. A second oxidant can also be introduced to the gasifier downstream of the first oxidant and the first hydrocarbon feedstock. The second oxidant can be introduced from a location that is external to the gasifier. At least a portion of the first hydrocarbon feedstock can be gasified to produce a syngas.

The gasification system for gasifying one or more hydrocarbon feedstocks can include a single gasifier or two or more gasifiers arranged in series and/or parallel. One or more oxidants and one or more hydrocarbon materials or feedstocks can be directed, fed, or otherwise introduced to the gasifier. Interspersing the introduction of the total amount of oxidant and hydrocarbon feedstock to the gasifier can help reduce or eliminate undesirable high temperatures within the gasifier by controlling, e.g., the various reactions that occur within the gasifier including the at least partial combustion, vaporization, cracking, and/or gasification of the hydrocarbon feedstock. Introduction of one or more oxidants and/or one or more hydrocarbon feedstocks can be interspersed along a length of the gasifier with respect to one another. The interspersion of the oxidants and the hydrocarbon feedstocks can be alternating with respect to one another. The distance between any two adjacent feeds, e.g., oxidant and hydrocarbon feedstock, can be the same or different as the distance between any two other adjacent feeds. Generally, the distance between any two adjacent feeds is a distance sufficient to provide for a mixing of the two adjacent feeds. Upon introduction to the gasifier, at least a portion of the one or more hydrocarbon feedstocks can be combusted, vaporized, cracked, and/or gasified to produce heat, combustion gas, vaporized hydrocarbons, cracked hydrocarbons, and/or gasified hydrocarbons (“synthesis gas” or “syngas”) within the gasifier. Controlling the ratio of oxidant to hydrocarbon feedstock can be used to adjust the heat produced via combustion and the resulting temperature increase that can then be used to drive other reactions therein, e.g., vaporization, cracking, and/or gasification.

Although three oxidants can be introduced to the gasifier as discussed and described herein, any number of oxidants can be directed, fed, or otherwise introduced to the gasifier. For example, the number of oxidants introduced to the gasifier can be 1, 2, 3, 4, 5, 6, 7, 8, 9, 10, or more. Similarly, while two hydrocarbon feedstocks can be directed, fed, or otherwise introduced to the gasifier as discussed and described herein, any number of hydrocarbon feedstocks can be introduced to the gasifier. For example, the number of hydrocarbon feedstocks introduced to the gasifier can be 1, 2, 3, 4, 5, 6, 7, 8, 9, 10, or more. In at least one example, two oxidants and one or two hydrocarbon feedstocks can be introduced to the gasifier. In at least one other example, three oxidants and two hydrocarbon feedstocks can be introduced to the gasifier. In at least one other example, four oxidants and three hydrocarbon feedstocks can be introduced to the gasifier.

The gasification system can also include one or more start-up heaters. The start-up heater can at least partially combust one or more start-up fuels to provide a start-up combustion gas that can assist in the start-up and/or the heat-up of the gasifier. It should be noted that the start-up combustion gas can be introduced to one or more locations within the gasifier. Alternatively, a start-up heater can indirectly transfer heat to a start-up medium that can then be introduced to the gasifier. Illustrative start-up mediums can include, but are not limited to, nitrogen, carbon dioxide, combustion gas products, e.g., a recycled combustion product, or any combination thereof.

Each gasifier can include one or more first mixing zones, one or more second mixing zones, one or more risers or gasification zones, one or more disengagers or separators, one or more standpipes, and one or more transfer lines. If the gasification system includes two or more gasifiers, each gasifier can be configured independent from the others or configured where any of the one or more mixing zones; gasification zones; separators; and/or standpipes can be shared. For simplicity and ease of description, embodiments of the gasifier will be further described in the context of a single reactor train.

The first oxidant and the start-up combustion gas (if used, e.g., during start-up of the gasifier) and/or the inert medium (if used, e.g., during heat-up of the gasifier) can be introduced to the first mixing zone and can flow from the first mixing zone and into the second mixing zone. The first hydrocarbon feedstock can be introduced to the second mixing zone. The circulating particulates can be introduced to the first mixing zone, the second mixing zone, and/or between the first mixing zone and the second mixing zone. At least a portion of the first hydrocarbon feedstock and/or at least a portion of any carbonaceous material deposited on the circulating particulates can be combusted, vaporized, cracked, and/or gasified to produce a first heat, a first combustion gas, vaporized hydrocarbons, cracked hydrocarbons, and/or gasified hydrocarbons (“syngas”) within the second mixing zone. The first hydrocarbon feedstock can be introduced to the first mixing zone generally downstream relative to the first oxidant.

The vaporization, cracking, and/or gasification of the first hydrocarbon feedstock and/or the carbonaceous material deposited on the circulating particulates as well as the particulates themselves can absorb at least a portion of the heat produced by combusting the at least a portion of the first hydrocarbon feedstock and/or the at least a portion of any carbonaceous material deposited on the circulating particulates. The amount of oxidant introduced to the first mixing zone can be based, at least in part, on the amount of the first hydrocarbon feedstock introduced and/or the amount of any carbon and/or carbonaceous material deposited on the circulating particulates. Controlling the amount of oxidant relative to the amount of carbonaceous material introduced can be used to control the temperature within the second mixing zone. In other words, the temperature increase caused by combusting the carbonaceous material can be controlled or moderated by controlling the amount of oxidant introduced. The resulting fluid/particulate mixture, e.g., first heat, first combustion gas, vaporized hydrocarbons, cracked hydrocarbons, and/or syngas, can flow through the second mixing zone toward the gasification zone.

Considering the heat, e.g, the first heat and/or the second heat as discussed and described herein, released by combusting at least a portion of the first hydrocarbon feedstock introduced, the second hydrocarbon feedstock introduced, and/or the carbonaceous material deposited on the circulating particulates, in more detail, the heat can be absorbed by the endothermic vaporization, cracking, and/or gasification reactions. Controlling the temperature of the large thermal mass of circulating particulates can help to moderate the temperature increase generally associated with combustion and can help to moderate the temperature decrease generally associated with vaporization, cracking, and/or gasification. For example, one or more hydrocarbon feedstocks can be introduced to the gasifier and at least partially gasified therein to produce gasified hydrocarbons (syngas). The gasified hydrocarbons (syngas) can include, but are not limited to, hydrogen, carbon monoxide, carbon dioxide, methane, nitrogen, steam, or any combination thereof. At least a portion of the one or more hydrocarbon feedstocks can also be combusted within the gasifier to produce a combustion gas. At least a portion of the one or more hydrocarbon feedstocks can also be vaporized in the presence of the combustion gas to produce vaporized hydrocarbons. At least a portion of the one or more hydrocarbon feedstocks can also be cracked in the presence of the gasified hydrocarbons to produce cracked hydrocarbons. At least a portion of the one or more hydrocarbon feedstocks can deposit onto the circulating particulates to produce carbon-containing particulates or “coked” particulates. At least a portion of the carbon deposited on the circulating particulates can be combusted within the gasifier to produce a portion of the combustion gas and circulating particulates. As such, the one or more hydrocarbon feedstocks can be combusted, vaporized, cracked, gasified, and/or deposited onto particulates within the gasifier. At least a portion of the combustion gas, vaporized hydrocarbons, cracked hydrocarbons, and/or gasified hydrocarbons can be selectively separated from the hydrocarbon containing particulates. For example, at least a portion of the gasified hydrocarbons can be selectively separated from the hydrocarbon containing particulates to provide a hot gas product or syngas. At least a portion of the carbon deposited on the circulating particulates can be a result of incomplete gasification and/or combustion of the one or more hydrocarbon feedstocks. At least a portion of the carbon deposited on the circulating particulates can continue to slowly gasify, can combust with oxidant to produce carbon monoxide, e.g., when the carbon-containing particulates are circulated from the gasification zone through the standpipe and the transfer or recycle line back to the first and/or second mixing zones, and/or can leave the gasifier with the coarse ash and/or the fine ash.

The first oxidant introduced to the first mixing zone, the first hydrocarbon feedstock introduced to the second mixing zone, and/or the particulates that can contain carbonaceous material deposited thereon introduced to the second mixing zone, can produce a first heat and a first temperature of one or more of the circulating particulates, e.g., a first temperature of at least a portion of the circulating particulates, within the second mixing zone. In other words, combustion of at least a portion of the carbonaceous material contained in the first hydrocarbon feedstock and/or deposited on the particulates can produce a first heat and one or more circulating particulates at the first temperature. At least a portion of the first heat can be absorbed by the vaporization, cracking, and/or gasification of volatile components and/or by the initiation of the gasification of the first hydrocarbon feedstock to help decrease the first temperature of the circulating particulates within the second mixing zone. The first temperature of one or more of the circulating particulates within the second mixing zone can range from a low of about 700° C., about 750° C., or about 800° C. to a high of about 900° C., about 950° C., or about 1,000° C. or more. For example, the first temperature of one or more of the circulating particulates within the second mixing zone can range from about 700° C. to about 1,000° C., about 725° C. to about 975° C., about 750° C. to about 950° C., or about 775° C. to about 925° C.

The second oxidant can be introduced to the second mixing zone downstream of the first hydrocarbon feedstock. In one or more embodiments, the second hydrocarbon feedstock can be introduced to the second mixing zone downstream of the second oxidant. In the presence of the second oxidant, at least a portion of the first hydrocarbon feedstock, any carbonaceous material deposited on the circulating particulates, and/or at least a portion of the second hydrocarbon feedstock can be combusted, vaporized, cracked, and/or gasified within the second mixing zone to produce a fluid/particulate mixture, e.g., a second heat, a second combustion gas, vaporized hydrocarbons, cracked hydrocarbons, and/or syngas. Similar to the reactions that can occur with the first hydrocarbon feedstock and/or the circulating particulates, with or without carbonaceous material deposited thereon, the second hydrocarbon feedstock can also absorb at least a portion of the heat produced by combusting at least a portion of the first hydrocarbon feedstock, at least a portion of the second hydrocarbon feedstock, and/or any carbonaceous material deposited and/or remaining on the circulating particulates. As such, the amount of the second oxidant introduced can be based, at least in part, on the amount of the first hydrocarbon feedstock introduced, the amount of any carbonaceous material deposited on the circulating particulates, and/or the amount of the second hydrocarbon feedstock introduced. Controlling the amount of the second oxidant relative to the amount of carbonaceous material within the second mixing zone can be used to control the temperature within the second mixing zone. In other words, the temperature increase caused by combusting the first hydrocarbon feedstock, any carbonaceous material deposited on the circulating particulates, and/or the second hydrocarbon feedstock can be controlled or moderated by controlling the amount of second oxidant introduced.

The second oxidant introduced to the second mixing zone can provide for an increase in the first temperature of circulating particulates within the second mixing zone to produce a second temperature of one or more of the circulating particulates, e.g., a second temperature of at least a portion of the circulating particulates. Combustion of at least a portion of the first hydrocarbon feedstock and/or any carbonaceous material deposited on the circulating particulates utilizing the second oxidant introduced can produce the second heat and can cause the increase in the first temperature of circulating particulates to produce one or more circulating particulates at the second temperature. The second temperature of one or more of the circulating particulates within the second mixing zone can range from a low of about 700° C., about 750° C., or about 800° C. to a high of about 900° C., about 950° C., or about 1,000° C. or more. For example, the second temperature of one or more of the circulating particulates within the second mixing zone can range from about 700° C. to about 1,000° C., about 725° C. to about 975° C., about 750° C. to about 950° C., or about 775° C. to about 925° C.

In one or more embodiments, the second hydrocarbon feedstock introduced to the second mixing zone can produce a third temperature of one or more of the circulating particulates, e.g., a third temperature of at least a portion of the circulating particulates, within the second mixing zone. At least a portion of the heat of combustion can be absorbed by the vaporization and/or cracking of volatile components, by the continuation of the gasification of the first hydrocarbon feedstock, by the initiation of the gasification of the second hydrocarbon feedstock, or a combination thereof to decrease the third temperature of circulating particulates within the second mixing zone. The third temperature of one or more of the circulating particulates within the second mixing zone can range from a low of about 700° C., about 750° C., or about 800° C. to a high of about 900° C., about 950° C., or about 1,000° C. or more. For example, the third temperature of one or more of the circulating particulates within the second mixing zone can range from about 700° C. to about 1,000° C., about 725° C. to about 975° C., about 750° C. to about 950° C., or about 775° C. to about 925° C.

In one or more embodiments, the third oxidant can be introduced to the second mixing zone and/or the gasification zone downstream from the second oxidant and/or the second hydrocarbon feedstock. Introduction of the third oxidant can be used to control or adjust the heat of the fluid/particulate mixture flowing toward and/or within the gasification zone. For example, if more heat is desired for carrying out the additional reactions, e.g., vaporization, cracking, and/or gasification of any remaining volatile components and/or hydrocarbon feedstock, within the gasification zone, the amount of the third oxidant can be increased. In another example, if less heat is desired for carrying out the additional reactions within the gasification zone, the amount of the third oxidant can be decreased or completely stopped. As such, the third oxidant can be referred to as a “trim” oxidant because the third oxidant can be used to adjust the temperature or amount of heat introduced to the gasification zone via the fluid/particulate mixture flowing into the gasification zone from the second mixing zone.

Introducing the third oxidant to the second mixing zone and/or the gasification zone can be used to produce and/or adjust a fourth temperature of one or more of the circulating particulates, e.g., a fourth temperature of at least a portion of the circulating particulates, within the second mixing zone and/or the gasification zone. For example, increasing the amount of the third oxidant to the second mixing zone and/or the gasification zone can help to increase the fourth temperature of one or more of the circulating particulates in the second mixing zone and/or the gasification zone. In another example, decreasing the amount of the third oxidant to the second mixing zone and/or the gasification zone can help to decrease the fourth temperature of one or more of the circulating particulates in the second mixing zone and/or the gasification zone. Thus, introducing the third oxidant to the second mixing zone and/or the gasification zone can help provide for an adjusting or tuning of the fourth temperature of one or more of the circulating particulates within the second mixing zone and/or the gasification zone.

The fourth temperature of one or more of the circulating particulates within the second mixing zone and/or the gasification zone can range from a low of about 700° C., about 750° C., or about 800° C. to a high of about 900° C., about 950° C., or about 1,000° C. or more. For example, the fourth temperature of one or more of the circulating particulates within the second mixing zone and/or the gasification zone can range from about 700° C. to about 1,000° C., about 725° C. to about 975° C., about 750° C. to about 950° C., or about 775° C. to about 925° C.

When utilizing the systems and methods for controlling the gasification of one or more hydrocarbon feedstocks as discussed and described herein, the first temperature of one or more of the circulating particulates within the second mixing zone, the second temperature of one or more of the circulating particulates within the second mixing zone, the third temperature of one or more of the circulating particulates within the second mixing zone, and/or the fourth temperature of one or more of the circulating particulates within the second mixing zone and/or the gasification zone can be the same or different. When the first temperature, the second temperature, the third temperature, and/or the fourth temperature are different, the difference can be about 150° C. or less, about 125° C. or less, about 100° C. or less, about 75° C. or less, about 50° C. or less, or about 25° C. or less, with respect to one another. For example, when the first, second, third, and/or fourth temperatures are different, the difference can range from a low of about 1° C., about 5° C., about 10° C., about 15° C., about 20° C., or about 25° C. to a high of about 100° C., about 110° C., about 120° C., about 130° C., about 140° C., or about 150° C., with respect to one another. In another example, when the first, second, third, and/or fourth temperatures are different, the difference can range from about 1° C. to about 150° C., about 5° C. to about 125° C., about 10° C. to about 100° C., about 15° C. to about 80° C., about 20° C. to about 75° C., about 25° C. to about 50° C., or about 25° C. to about 45° C., with respect to one another. In another example, the difference between the first and second temperature, or the difference between the second and third temperature, or the difference between the third and fourth temperature can range from a low of about 1° C., about 5° C., about 10° C., about 15° C., about 20° C., or about 25° C. to a high of about 100° C., about 110° C., about 120° C., about 130° C., about 140° C., or about 150° C., with respect to one another. In another example, the difference between the first and second temperature, or the difference between the second and third temperature, or the difference between the third and fourth temperature can range from about 1° C. to about 150° C., about 5° C. to about 125° C., about 10° C. to about 100° C., about 15° C. to about 80° C., about 20° C. to about 75° C., about 25° C. to about 50° C., or about 25° C. to about 45° C., with respect to one another.

Reactions within the riser or gasification zone can include, but are not limited to, vaporization, cracking, and/or gasification of any remaining carbonaceous materials introduced and/or the carbonaceous material containing particulates. Additionally, carbonaceous material, e.g., carbon, from the one or more hydrocarbon feedstocks, e.g., the first and/or second hydrocarbon feedstocks, can be deposited onto the particulates within the second mixing zone and/or the gasification zone to provide particulates having carbonaceous material deposited thereon. As discussed in more detail below, at least a portion of the circulating particulates having carbonaceous material deposited thereon can be recirculated or recycled to the first mixing zone, the second mixing zone, and/or the gasification zone, e.g., in sequence, and/or between the first and second mixing zones.

The temperature within the gasification zone can be sufficient to gasify at least a portion of any remaining hydrocarbon feedstock, e.g., the first hydrocarbon feedstock and/or the second hydrocarbon feedstock, and/or carbonaceous material deposited on the circulating particulates to produce a fluid/particulate mixture or “syngas.” For example, the temperature within the gasification zone can be sufficient to gasify all of the remaining hydrocarbon feedstock, e.g., the first hydrocarbon feedstock and/or the second hydrocarbon feedstock, and/or carbonaceous material deposited on the circulating particulates. In another example, the temperature within the gasification zone can be sufficient to gasify, crack, vaporize, and/or deposit the carbonaceous material introduced thereto in the form of the hydrocarbon feedstock, e.g., the first hydrocarbon feedstock and/or the second hydrocarbon feedstock and/or as carbonaceous material deposited on the circulating particulates. The temperature within the gasification zone can range from a low of about 700° C., about 750° C., or about 800° C. to a high of about 900° C., about 950° C., about 1,000° C., about 1,100° C., about 1,200° C. or more. For example, the temperature within the gasification zone can range from about 700° C. to about 1,150° C., about 750° C. to about 1,050° C., about 775° C. to about 975° C., or about 800° C. to about 950° C.

If the temperature of the one or more circulating particulates in the second mixing zone and/or the gasification zone and the temperature within the gasification zone can be maintained in the ranges disclosed herein by introducing the oxidant and the hydrocarbon feedstock, e.g., the first oxidant, the first hydrocarbon feedstock, and the second oxidant, as disclosed herein, then introducing the second hydrocarbon feedstock and the third oxidant can be postponed or eliminated. Also, for example, if the temperature of the one or more circulating particulates in the second mixing zone and/or the gasification zone and the temperature within the gasification zone can be maintained in the ranges disclosed herein by introducing the oxidant and the hydrocarbon feedstock, e.g., the first oxidant, the first hydrocarbon feedstock, the second oxidant, and the second hydrocarbon feedstock as disclosed herein, then introducing the third oxidant can be postponed or eliminated. Also, for example, if the temperature of the one or more circulating particulates in the second mixing zone and/or the gasification zone and the temperature within the gasification zone can be maintained in the ranges disclosed herein by introducing the oxidant and the hydrocarbon feedstock, e.g., the first oxidant, the first hydrocarbon feedstock, the second oxidant, and the third oxidant as disclosed herein, then introducing the second hydrocarbon feedstock can be postponed or eliminated. As such, the methods and systems discussed and described herein can be used to adjust or tune the operation of the gasifier to maintain the desired temperatures within the second mixing zone and the gasification zone.

The order of addition of the oxidant and the hydrocarbon feedstock, e.g., the first oxidant, the second oxidant, the third oxidant, the first hydrocarbon feedstock, and/or the second hydrocarbon feedstock, can be in any order as long as the temperature of the one or more circulating particulates in the second mixing zone and/or the gasification zone, and the temperature within the gasification zone, can be maintained as discussed and described herein. The time period of introduction of the oxidant and the hydrocarbon feedstock, e.g., the first oxidant, the second oxidant, the third oxidant, the first hydrocarbon feedstock, and/or the second hydrocarbon feedstock, can be any time period as long as the temperature of the one or more circulating particulates in the second mixing zone and/or gasification zone, and the temperature within the gasification zone, can be maintained as discussed and described herein. For example, the second hydrocarbon feedstock can be introduced while the first hydrocarbon feedstock is discontinued for a period of time and then the first hydrocarbon feedstock can be reintroduced. In another example, the second oxidant can be introduced while the first oxidant, the third oxidant, or both is/are discontinued for a period of time and then the first oxidant, the third oxidant, or both can be reintroduced. In yet another example, the third oxidant can be introduced while the first oxidant, the second oxidant, or both is/are discontinued for a period of time and then the first oxidant, the second oxidant, or both can be reintroduced.

The time period for contacting two adjacent feeds, e.g., contacting the first oxidant and the first hydrocarbon feedstock, or contacting the first hydrocarbon feedstock and the second oxidant, or contacting the second oxidant and the second hydrocarbon feedstock, or contacting the second hydrocarbon feedstock and the third oxidant, can be any time period as long as the temperature of the one or more circulating particulates in second mixing zone and/or gasification zone, and the temperature within the gasification zone, can be maintained as discussed and described herein. Generally, the time period for contacting two adjacent feeds can provide for reacting, e.g., combusting, vaporizing, cracking, and/or gasifying, within the second mixing zone to produce, e.g., a first heat, a first combustion gas, a second heat, a second combustion gas, vaporized hydrocarbons, cracked hydrocarbons, and/or syngas. Generally, the time period for contacting two adjacent feeds can be about 0.1 seconds, about 0.2 seconds, about 0.3 seconds, about 0.4 seconds, about 0.5 seconds, about 1 second, about 2 seconds, about 5 seconds, about 10 seconds, or more.

The fluid/particulate mixture or syngas produced within the first mixing zone, the second mixing zone, and/or the gasification zone can be introduced to the first separator where at least a portion of the particulates can be separated therefrom to provide a first separated syngas and separated particulates. All or a portion of the separated particulates can be introduced to the standpipe. All or a portion of the separated particulates can be removed from the gasifier. Removing particulates from the gasifier can be used to control the height of particulates within the standpipe and/or the total amount of particulates circulating within the gasifier. The first separated gas can be introduced to the second separator where a second portion, if any, of the particulates can be separated therefrom to produce a separated gas product or a separated syngas and to produce separated particulates that can be introduced to the standpipe. The separators can be or include any device, system, or combination of devices and/or systems capable of separating or removing at least a portion of the particulates from the fluid/particulate mixture. Illustrative separators can include, but are not limited to, cyclones, desalters, and/or decanters.

As discussed above, the particulates that can include carbonaceous material deposited thereon can be recycled via the transfer or “recycle” line from the standpipe to the first mixing zone, the second mixing zone, and/or the gasification zone, e.g., in sequence, and/or between the first and second mixing zones. The particulates can be loaded or otherwise disposed within the gasifier prior to introducing the start-up combustion gas and/or the inert medium to the gasifier when the start-up heater is utilized to start-up or heat-up the gasifier or operation of the gasifier is otherwise initiated. As such, circulation of particulates can begin prior to introducing the start-up combustion gas and/or the inert medium to the first mixing zone. One or more fluids can be introduced to the one or more transfer lines, the standpipe, and/or the recycle line, in order to provide one or more motive fluids within the gasifier for circulating the particulates within the gasifier. Illustrative motive fluids introduced to the gasifier can include, but are not limited to, inert gases such as nitrogen, combustible gases such as recycled syngas, carbon dioxide, combustion gases, or any combination thereof.

The hydrocarbon feedstock, e.g., the first hydrocarbon feedstock and/or the second hydrocarbon feedstock, can be introduced to the second mixing zone. In another example, the hydrocarbon feedstock, e.g., the first hydrocarbon feedstock and/or the second hydrocarbon feedstock, can be introduced to the first mixing zone, the second mixing zone, the gasification zone, and/or the transfer line connecting the gasification zone and the first separator.

The oxidant and the hydrocarbon feedstock, e.g., the first oxidant, the second oxidant, the third oxidant, the first hydrocarbon feedstock, and/or the second hydrocarbon feedstock, can be introduced to the gasifier continuously, intermittently, simultaneously, separately, sequentially, or a combination thereof.

One or more valves or other flow restricting devices can be used to control or adjust the amount of the oxidant, the start-up combustion gas, the inert medium, the hydrocarbon feedstock, e.g., the first hydrocarbon feedstock and/or the second hydrocarbon feedstock, the hot gas product or syngas, the one or more motive fluids, and/or the particulates.

The amount of oxidant introduced as the first oxidant can range from a low of about 35%, about 40%, or about 45% to a high of about 90%, about 95%, about 99%, about 99.9%, or about 100%, based on the total amount of oxidant introduced to the gasifier, e.g. the total amount of oxidant in the first, second, and third oxidants. For example, the amount of oxidant introduced as the first oxidant can range from about 35% to about 100%, about 40% to about 99.9%, about 45% to about 95%, or about 50% to about 90%, based on the total amount of oxidant introduced to the gasifier. The amount of oxidant introduced as the second oxidant can range from a low of about 15%, about 20%, or about 25% to a high of about 45%, about 50%, about 55%, about 60%, or about 65%, based on the total amount of oxidant introduced to the gasifier. For example, the amount of oxidant introduced as the second oxidant can range from about 15% to about 65%, about 20% to about 60%, about 25% to about 55%, or about 30% to about 50%, based on the total amount of oxidant introduced to the gasifier. In one or more embodiments, the amount of oxidant introduced as the third oxidant can range from a low of about 5%, about 10%, or about 15% to a high of about 35%, about 40%, about 45%, about 50%, or about 55%, based on the total amount of oxidant introduced to the gasifier. For example, the amount of oxidant introduced as the third oxidant can range from about 5% to about 55%, about 10% to about 50%, about 15% to about 45%, or about 20% to about 40%, based on the total amount of oxidant introduced to the gasifier.

The amount of carbonaceous material introduced as the first hydrocarbon feedstock to the gasifier can range from a low of about 15%, about 25%, or about 30% to a high of about 60%, about 70%, about 80%, about 90%, or about 100%, based on the total amount of carbonaceous material introduced to the gasifier, e.g. the total amount of carbonaceous material in the first and second hydrocarbon feedstocks. For example, the amount of the first hydrocarbon feedstock can range from about 25% to about 95%, about 25% to about 75%, about 35% to about 75%, about 40% to about 75%, or about 50% to about 65%, based on the total amount of carbonaceous material introduced to the gasifier. In one or more embodiments, the amount of carbonaceous material introduced as the second hydrocarbon feedstock to the gasifier can range from a low of about 15%, about 25%, or about 30% to a high of about 60%, about 70%, about 80%, about 90%, or about 100%, based on the total amount of carbonaceous material introduced to the gasifier. For example, the amount of the second hydrocarbon feedstock can range from about 25% to about 95%, about 25% to about 75%, about 35% to about 75%, about 40% to about 75%, or about 50% to about 65%, based on the total amount of carbonaceous material introduced to the gasifier. When the carbonaceous material is introduced as the first hydrocarbon feedstock and the second hydrocarbon feedstock, the weight ratio of the first hydrocarbon feedstock to the second hydrocarbon feedstock can be about 80:20, about 75:25, about 70:30, about 65:35, about 60:40, about 55:45, or about 50:50.

The total amount of oxidant introduced to the gasifier, e.g, the oxidant introduced as the first oxidant, the second oxidant, and/or the third oxidant, can be less than about 60%, less than about 50%, less than about 40%, or less than about 30% of the stoichiometric amount of oxidant required for complete combustion of all the carbon introduced to the gasifier. The molar ratio of oxygen to carbon within the gasifier can be maintained at a sub-stoichiometric proportion to promote the formation of carbon monoxide over carbon dioxide within the gasifier. The molar ratio of total oxidant introduced to the gasifier, e.g., the total amount of oxidant in the first, second, and third oxidants, to the total amount of carbonaceous material introduced to the gasifier, e.g., the total amount of carbonaceous material in the first and second hydrocarbon feedstocks, can be about 0.15:1, about 0.20:1, about 0.24:1, about 0.30:1, or about 0.35:1. The molar ratio of the total oxidant introduced to the gasifier to the total amount of carbonaceous material introduced to the gasifier can range from about 0.10:1 to about 0.50:1, about 0.15:1 to about 0.45:1, about 0.20:1 to about 0.40:1, or about 0.24:1 to about 0.35:1.

In one or more embodiments, the oxidant, e.g., the first oxidant, the second oxidant, and the third oxidant, can be the same or different with respect to one another. In one or more embodiments, the hydrocarbon feedstock, e.g., the first hydrocarbon feedstock and the second hydrocarbon feedstock, can be the same or different with respect to one another. In one or more embodiments, the oxidant and the hydrocarbon feedstock, e.g., the first oxidant, the second oxidant, the third oxidant, the first hydrocarbon feedstock, and/or the second hydrocarbon feedstock, can be introduced to the gasifier from a source and/or location external to the gasifier.

As used herein, the term “hydrocarbon feedstock” refers to one or more carbon containing materials, whether solid, liquid, gas, or any combination thereof. For example, the hydrocarbon feedstock can include a mixture or combination of two or more carbonaceous materials. Examples of a suitable carbonaceous materials can include, but are not limited to, biomass (i.e., plant and/or animal matter or plant and/or animal derived matter); coal (high-sodium and low-sodium lignite, lignite, subbituminous, and/or anthracite, for example); oil shale; coke; tar; asphaltenes; bitumens, low ash or no ash polymers; hydrocarbon-based polymeric materials; biomass derived material; or by-products derived from manufacturing operations. Examples of suitable hydrocarbon-based polymeric materials can include, but are not limited to, thermoplastics, elastomers, rubbers, including polypropylenes, polyethylenes, polystyrenes, including other polyolefins, homo polymers, copolymers, block copolymers, and blends thereof; PET (polyethylene terephthalate), poly blends, poly-hydrocarbons containing oxygen; heavy hydrocarbon sludge and bottoms products from petroleum refineries and petrochemical plants such as hydrocarbon waxes; blends thereof, derivatives thereof and combinations thereof.

The hydrocarbon feedstock can also include one or more carbonaceous materials combined with one or more discarded consumer products, for example, carpet and/or plastic automotive parts/components including bumpers and dashboards. Such discarded consumer products can preferably be reduced in size to fit within a gasifier. The hydrocarbon feedstock can include one or more recycled plastics, for example, polypropylene, polyethylene, polystyrene, derivatives thereof, blends thereof, or any combination thereof. Accordingly, the systems and methods discussed and described herein can be useful for accommodating mandates for proper disposal of previously manufactured materials.

The hydrocarbon feedstock, e.g., the first hydrocarbon feedstock and/or the second hydrocarbon feedstock, if solid, can have an average particle size ranging from a low of about 1 μm, about 10 μm, about 50 μm, about 100 μm, about 150 μm, or about 200 μm to a high of about 350 μm, about 400 μm, about 450 μm, or about 500 μm. For example, the average particle size of the hydrocarbon feedstock, e.g., the first hydrocarbon feedstock and/or the second hydrocarbon feedstock, if solid, can range from about 75 μm to about 475 μm, about 125 μm to about 425 μm, or about 175 μm to about 375 μm. In another example, the hydrocarbon feedstock, e.g., the first hydrocarbon feedstock and/or the second hydrocarbon feedstock, if solid, can be ground to have an average particle size of about 300 μm or less. The hydrocarbon feedstock, e.g., the first hydrocarbon feedstock and/or the second hydrocarbon feedstock, if solid, can be introduced to the gasifier as a dry feed or can be conveyed to the gasifier as a slurry or suspension. Suitable fluids for forming a slurry or suspension can include, but are not limited to, carbon dioxide, steam, water, nitrogen, air, syngas, or a combination thereof.

As used herein, the term “oxidant” includes any oxygen containing compound capable of contributing to the combustion of at least a portion of the hydrocarbon feedstock, e.g., the first hydrocarbon feedstock and/or the second hydrocarbon feedstock, and/or any carbonaceous material deposited on the circulating particulates. Illustrative oxidants can include, but are not limited to, air, oxygen, essentially oxygen, oxygen-enriched air, mixtures of oxygen and air, mixtures of air and/or oxygen with steam, mixtures of oxygen and one or more inert gases, for example, nitrogen and/or argon, or any combination thereof. The oxidant, e.g., the first oxidant, the second oxidant, and/or the third oxidant, can contain about 20 vol % oxygen or more, about 30 vol % oxygen or more, about 40 vol % oxygen or more, about 50 vol % oxygen or more, about 60 vol % oxygen or more, about 65 vol % oxygen or more, about 70 vol % oxygen or more, about 75 vol % oxygen or more, about 80 vol % oxygen or more, about 85 vol % oxygen or more, about 90 vol % oxygen or more, about 95 vol % oxygen or more, or about 99 vol % oxygen or more. As used herein, the term “essentially oxygen” refers to an oxygen stream containing more than 50 vol % oxygen. As used herein, the term “oxygen-enriched air” refers to a gas mixture containing from about 21 vol % oxygen to about 50 vol % oxygen. Oxygen-enriched air and/or essentially oxygen can be obtained, for example, from cryogenic distillation of air, pressure swing adsorption, membrane separation, or a combination thereof. The oxidant, e.g., the first oxidant, the second oxidant, and/or the third oxidant, can be nitrogen-free or essentially nitrogen-free. As used herein, the term “essentially nitrogen-free” refers to an oxidant that contains about 5 vol % nitrogen or less, about 4 vol % nitrogen or less, about 3 vol % nitrogen or less, about 2 vol % nitrogen or less, or about 1 vol % nitrogen or less.

The arrangement of the gasifier can be any arrangement that suitably provides for the gasification of the hydrocarbon feedstock, e.g., the first hydrocarbon feedstock and/or the second hydrocarbon feedstock, and/or carbonaceous material deposited on the circulating particulates as discussed and described herein. The gasifier can be arranged or oriented vertically, horizontally, or any angle therebetween. For example, when the arrangement of the gasifier is vertical, the first mixing zone and the second mixing zone can be referred to as a “lower” or an “upstream” mixing zone and an “upper” or a “downstream” mixing zone, respectively. As such, the first hydrocarbon feedstock can be introduced to the second or “upper” or “downstream” mixing zone that is above or downstream of the first oxidant introduced to the first or “lower” or “upstream” mixing zone. The second oxidant can be introduced to the second or “upper” or “downstream” mixing zone above or downstream of the first hydrocarbon feedstock. The second hydrocarbon feedstock can be introduced to the second or “upper” or “downstream” mixing zone above or downstream of the second oxidant. The third oxidant can be introduced to the second or “upper” or “downstream” mixing zone and/or to the gasification zone above or downstream of the second oxidant and/or the second hydrocarbon feedstock. The vertical arrangement discussed and described herein can provide for an interspersed introduction of the oxidant and the hydrocarbon feedstock, e.g., the first, second, and third oxidants and the first and second hydrocarbon feedstocks, to the gasifier.

When the arrangement of the gasifier is horizontal, the first mixing zone and the second mixing zone can be referred to as an “upstream” mixing zone and a “downstream” mixing zone, respectively. For example, the first hydrocarbon feedstock can be introduced to the second or “downstream” mixing zone after or downstream of the first oxidant introduced to the first or “upstream” mixing zone. The second oxidant can be introduced to the second or “downstream” mixing zone after or downstream of the first hydrocarbon feedstock. The second hydrocarbon feedstock can be introduced to the second or “downstream” mixing zone after or downstream of the second oxidant. The third oxidant can be introduced to the second or “downstream” mixing zone and/or the gasification zone after or downstream of the second oxidant and/or the second hydrocarbon feedstock. The horizontal arrangement discussed and described herein can provide for an interspersed introduction of the oxidant and the hydrocarbon feedstock, e.g., the first, second, and third oxidants and the first and second hydrocarbon feedstocks, to the gasifier.

It should be understood that the terms “upstream” and “downstream” are to indicate the position(s) of the oxidant and the hydrocarbon feedstock, e.g., the first oxidant, the second oxidant, the third oxidant, the first hydrocarbon feedstock, and/or the second hydrocarbon feedstock, with respect to one another. The terms “upstream” and “downstream” are not meant to limit the arrangement of the gasifier.

The syngas can contain about 85 vol % or more carbon monoxide and hydrogen with the balance being primarily carbon dioxide and methane. The syngas can contain about 90 vol % or more carbon monoxide and hydrogen, about 95 vol % or more carbon monoxide and hydrogen, about 97 vol % or more carbon monoxide and hydrogen, or about 99 vol % or more carbon monoxide and hydrogen. The carbon monoxide content of the syngas can range from a low of about 10 vol %, about 20 vol %, or about 30 vol % to a high of about 50 vol %, about 70 vol %, or about 85 vol %. The hydrogen content of the syngas can range from a low of about 1 vol %, about 5 vol %, or about 10 vol % to a high of about 30 vol %, about 40 vol %, or about 50 vol %. For example, the hydrogen content of the syngas can range from about 20 vol % to about 30 vol %.

The syngas can contain less than about 25 vol %, less than about 20 vol %, less than about 15 vol %, less than about 10 vol %, or less than about 5 vol % of combined nitrogen, methane, carbon dioxide, water, hydrogen sulfide, and hydrogen chloride. The carbon dioxide content of the syngas can be about 25 vol % or less, about 20 vol % or less, about 15 vol % or less, about 10 vol % or less, about 5 vol % or less, about 3 vol % or less, about 2 vol % or less, or about 1 vol % or less. The methane content of the syngas can be about 15 vol % or less, about 10 vol % or less, about 5 vol % or less, about 3 vol % or less, about 2 vol % or less, or about 1 vol % or less. The water content of the syngas can be about 40 vol % or less, about 30 vol % or less, about 25 vol % or less, about 20 vol % or less, about 15 vol % or less, about 10 vol % or less, about 5 vol % or less, about 3 vol % or less, about 2 vol % or less, or about 1 vol % or less. The syngas can be nitrogen-free or essentially nitrogen-free. For example, the syngas can contain less than about 3 vol %, less than about 2 vol %, less than about 1 vol %, or less than about 0.5 vol % nitrogen.

The syngas can have a heating value, corrected for heat loss and dilution effects, of about 1,863 kJ/m³ to about 2,794 kJ/m³, about 1,863 kJ/m³ to about 3,726 kJ/m³, about 1,863 kJ/m³ to about 4,098 kJ/m³, about 1,863 kJ/m³ to about 5,516 kJ/m³, about 1,863 kJ/m³ to about 6,707 kJ/m³, about 1,863 kJ/m³ to about 7,452 kJ/m³, about 1,863 kJ/m³ to about 9,315 kJ/m³, about 1,863 kJ/m³ to about 10,264 kJ/m³, about 1,863 kJ/m³ to about 11,178 kJ/m³, about 1,863 kJ/m³ to about 13,041 kJ/m³, or about 1,863 kJ/m³ to about 14,904 kJ/m³.

The syngas can be further processed according to any desired manner. For example, at least a portion of the syngas can be directed to a gas or combustion turbine which can be coupled to a generator to produce electrical power. In another example, at least a portion of the syngas can be used to produce a hydrogen product. In another example, at least a portion of the syngas can be directed to one or more gas converters to produce one or more Fisher-Tropsch products, methanol, ammonia, chemicals, hydroformylation products, and/or feedstocks, derivatives thereof, and/or combinations thereof.

Various types of gasifiers can be utilized as discussed and described herein. For example, the gasifier can be or include one or more circulating solids or transport gasifiers, one or more fixed bed gasifiers, one or more fluidized bed gasifiers, one or more entrained flow gasifiers, or a combination thereof. An example gasifier suitable for use according to one or more embodiments discussed and described herein can be a TRIG™ gasifier. The particulates or solids within the gasifier, in addition to or in lieu of serving one or more other purposes, e.g., as a deposition surface for a portion of the hydrocarbon feedstock, e.g., the first hydrocarbon feedstock and/or the second hydrocarbon feedstock, the presence of the particulates or solids within the gasifier can help to improve heat retention within the gasifier and/or can help to improve heat distribution throughout the gasifier.

In one or more embodiments, the gasification zone of the gasifier can have a smaller cross-sectional area, e.g., diameter, than the first mixing zone and/or the second mixing zone. The residence time within the gasification zone can provide for char gasification, methane/steam reforming, tar cracking, water-gas shift reactions, and/or sulfur capture reactions. Generally, the residence time and high temperature conditions within the gasification zone can provide for a gasification reaction to reach equilibrium. The residence time of the hydrocarbon feedstock, e.g., the first hydrocarbon feedstock and/or the second hydrocarbon feedstock, within the second mixing zone can be about 0.5 seconds, about 1 second, about 2 seconds, about 5 seconds, about 10 seconds, or more. The gas velocity through the gasification zone can range from about 3 meters per second (m/s) to about 28 m/s, from about 6 m/s to about 25 m/s, from about 9 m/s to about 22 m/s, from about 10 m/s to about 20 m/s, or from about 9 m/s to about 15 m/s. The gasification zone can operate at a higher temperature than the second mixing zone. The gasifier can be operated at a pressure ranging from about 50 kPa to about 5,000 kPa, about 101 kPa to about 4,480 kPa, about 350 kPa to about 4,130 kPa, or about 690 kPa to about 3,790 kPa.

The particulates or solids within the gasifier can include, but are not limited to, sand, ash, ceramic, limestone, or any combination thereof. The limestone can be crushed, pulverized, ground, powdered, or otherwise reduced in particle size. The ash can include any type of ash or mixtures thereof. Illustrative ash can include, but is not limited to, fly ash, gasifier ash, coarse ash, fine ash, or any combination thereof. As used herein, the terms “coarse ash” and “coarse ash particulates” are used interchangeably and refer to particulates produced within the gasifier and having an average particle size ranging from a low of about 35 μm, about 45 μm, about 50 μm, about 75 μm or about 100 μm to a high of about 450 μm, about 500 μm, about 550 μm, about 600 μm, or about 640 μm. For example, coarse ash particulates can have an average particle size of from about 40 μm to about 350 μm, about 50 μm to about 250 μm, about 65 μm to about 200 μm, or about 85 μm to about 130 μm. As used herein, the terms “fine ash” and “fine ash particulates” are used interchangeably and refer to particulates produced within the gasifier and having an average particle size ranging from a low of about 2 μm, about 5 μm, or about 10 μm to a high of about 75 μm, about 85 μm, or about 95 μm. For example, fine ash particulates can have an average particle size of from about 5 μm to about 30 μm, about 7 μm to about 25 μm, or about 10 μm to about 20 μm.

For a fixed particulate bed gasifier, the particulates can be disposed within the gasifier prior to starting the gasifier. For a circulating solids or transport gasifier, the particulates can be introduced at any desired time, for example, before and/or during starting of the gasifier. For example, the particulates can be introduced or loaded into the gasifier prior to introducing the start-up combustion gas and/or the heat-up gas from the start-up heater and/or the hydrocarbon feedstock introduced to the second mixing zone, e.g., the first hydrocarbon feedstock introduced to the second mixing zone, and/or the second hydrocarbon feedstock introduced to the second mixing zone. In another example, at least a portion of the particulates can be introduced to the gasifier prior to introducing the start-up combustion gas and/or the heat-up gas from the start-up heater. In another example, additional particulates can be introduced to the gasifier while introducing the start-up combustion gas and/or the heat-up gas from the start-up heater. In another example, additional particulates can be introduced after the start-up combustion gas and/or heat-up gas is introduced to the gasifier but before introduction of the hydrocarbon feedstock to the second mixing zone, e.g., the first and/or the second hydrocarbon feedstock to the second mixing zone.

One or more sorbents can also be introduced to the gasifier. The sorbents can capture one or more contaminants from the syngas, such as sodium vapor in the gas phase within the gasifier. The sorbents can be used to dust or coat the particles of the hydrocarbon feedstock, e.g., the first hydrocarbon feedstock and/or the second hydrocarbon feedstock, prior to introduction to or within the gasifier to reduce the tendency for the particles to agglomerate. The sorbents can be ground to an average particle size of about 5 microns to about 100 microns, or about 10 microns to about 75 microns. Illustrative sorbents can include, but are not limited to, carbon rich ash, limestone, dolomite, and coke breeze. Residual sulfur released from the hydrocarbon feedstock, e.g., the first hydrocarbon feedstock and/or the second hydrocarbon feedstock, can be captured by native calcium in the hydrocarbon feedstock, e.g., the first hydrocarbon feedstock and/or the second hydrocarbon feedstock, or by a calcium based sorbent, to form calcium sulfide.

An illustrative gasification system can include one or more gasifiers, particulate removal systems, first zones or first heat exchangers, and second zones or second heat exchangers. For example, the first zone can be a particulate or fluid/particulate mixture cooling system, and the second zone can be a syngas cooler. The gasification system can also include one or more converters to produce Fischer-Tropsch products, chemicals, and/or feedstocks, including ammonia and methanol. The gasification system can also include one or more hydrogen separators, fuel cells, combustion turbines, steam turbines, waste heat boilers, and generators to produce fuel, power, steam and/or energy. The gasification system can also include an air separation unit (“ASU”) for the production of essentially nitrogen-free syngas.

One or more particulate removal systems can be used to partially or completely remove any particulates from the syngas to provide the particulates or particulate-containing fluid and a separated syngas. The particulate removal system can include a separation device for example conventional disengagers and/or cyclones. Particulate control devices (“PCD”) capable of providing an outlet particulate concentration below the detectable limit of about 0.1 parts per million by weight (ppmw) can also be used. Examples of suitable PCDs can include, but are not limited to, sintered metal filters, metal filter candles, and ceramic filter candles (for example, iron alum inide filter material). The particulates, for example, fine ash, coarse ash, and combinations thereof, can be recycled to the gasifier, purged from the system, utilized as the particulates, or any combination thereof.

The separated syngas can be cooled in one or more syngas coolers. For example, the syngas can be cooled to about 538° C. or less, about 482° C. or less, about 427° C. or less, about 371° C. or less, about 316° C. or less, about 260° C. or less, about 204° C. or less, or about 149° C. or less. The separated and/or cooled syngas can be treated within a gas purification system to remove contaminants. The gas purification system can include a system, a process, or a device to remove sulfur and/or sulfur-containing compounds from the syngas. Examples of a suitable catalytic gas purification system include, but are not limited to, systems using zinc titanate, zinc ferrite, tin oxide, zinc oxide, iron oxide, copper oxide, cerium oxide, or mixtures thereof. Examples of a suitable process-based gas purification system include, but are not limited to, the SELEXOL® process, the RECTISOL® process, the CRYSTASULF® process, and the Sulfinol gas treatment process.

One or more amine solvents such as methyl-diethanolamine (MDEA) can be used to remove acid gas from the syngas. Physical solvents, for example SELEXOL® (dimethyl ethers of polyethylene glycol) or RECTISOL® (cold methanol), can also be used. If the syngas contains carbonyl sulfide (COS), the carbonyl sulfide can be converted by hydrolysis to hydrogen sulfide by reaction with water over a catalyst and then absorbed using the methods described above. If the syngas contains mercury, the mercury can be removed using a bed of sulfur-impregnated activated carbon.

One or more catalysts, such as a cobalt-molybdenum (“Co-Mo”) catalyst can be incorporated into the gas purification system to perform a sour shift conversion of the syngas. The Co-Mo catalyst can operate at a temperature of about 288° C. in the presence of H₂S, for example, about 100 parts per million by weight (ppmw) H₂S. If a Co-Mo catalyst is used to perform a sour shift, subsequent downstream removal of sulfur can be accomplished using any of the above described sulfur removal methods and/or techniques.

The syngas from the gas purification system can be combusted to produce or generate power and/or steam. The syngas can be sold as a commodity. The syngas can be used to produce Fischer-Tropsch products, chemicals, and/or feedstocks. Hydrogen can be separated from the syngas and used in hydrogenation processes, fuel cell energy processes, ammonia production, and/or as a fuel. Carbon monoxide can be separated from the syngas and used for the production of chemicals, for example, acetic acid, phosgene/isocyanates, formic acid, and propionic acid.

One or more gas converters can be used to convert the syngas into one or more Fischer-Tropsch products, chemicals, and/or feedstocks. The gas converter can include a shift reactor to adjust the hydrogen to carbon monoxide ratio (H₂:CO) of the syngas by converting CO to CO₂. Within the shift reactor, a water-gas shift reaction reacts at least a portion of the carbon monoxide in the syngas with water in the presence of a catalyst and a high temperature to produce hydrogen and carbon dioxide. Examples of a suitable shift reactor can include, but are not limited to, single stage adiabatic fixed bed reactors, multiple-stage adiabatic fixed bed reactors with interstage cooling, steam generation or cold quench reactors, tubular fixed bed reactors with steam generation or cooling, fluidized bed reactors, or any combination thereof. A sorption enhanced water-gas shift (SEWGS) process, utilizing a pressure swing adsorption unit having multiple fixed bed reactors packed with shift catalyst and at high temperature, e.g. a carbon dioxide adsorbent at about 480° C., can be used. Various shift catalysts can be employed.

The shift reactor can include two reactors arranged in series. A first reactor can be operated at high temperature (about 340° C. to about 400° C.) to convert a majority of the CO present in the syngas to CO, at a relatively high reaction rate using an iron-chrome catalyst. A second reactor can be operated at a relatively low temperature (about 145° C. to about 205° C.) to complete the conversion of CO to CO₂ using a mixture of copper oxide and zinc oxide.

The recovered carbon dioxide from the shift reactor can be used in a fuel recovery process to enhance the recovery of oil and gas. In an illustrative oil recovery process, carbon dioxide can be injected and flushed into an area beneath an existing well where “stranded” oil exists. The water and carbon dioxide removed with the crude oil can then be separated and recycled.

The gas converter can be used to produce one or more Fischer-Tropsch products. The one or more Fischer-Tropsch products can include, but are not limited to, one or more hydrocarbons having a wide range of molecular weights, spanning from light gaseous hydrocarbons (C1-C4), naphtha (C5-C10), diesel (C11-C20), and wax (>C20), derivatives thereof, or combinations thereof. Illustrative Fischer-Tropsch products can include, but are not limited to, diesel fuels, kerosene, aviation fuels, propane, butane, LPG, lubricants, naphtha, gasoline, detergents, waxes, lubricants, refinery/petrochemical feedstocks, other transportation fuels, synthetic crude oil, liquid fuels, alpha olefins, derivatives thereof, mixtures thereof, or combinations thereof. The reaction can be carried out in any type reactor, for example, fixed bed, moving bed, fluidized bed, slurry, or bubbling bed using copper, ruthenium, iron or cobalt based catalysts, or combination thereof, under conditions ranging from about 190° C. to about 450° C. depending on the reactor configuration.

The Fischer-Tropsch products are liquids which can be shipped to a refinery site for further chemically reacting and upgrading to a variety of products. Certain products, for example C4-C5 hydrocarbons, can be high quality paraffin solvents which, if desired, can be hydrotreated to remove olefin impurities, or employed without hydrotreating to produce a wide variety of wax products. C16+ liquid hydrocarbon products can be upgraded by various hydroconversion reactions, for example, hydrocracking, hydroisomerization catalytic dewaxing, isodewaxing, or combinations thereof, to produce mid-distillates, diesel and jet fuels for example low freeze point jet fuel and high cetane jet fuel, isoparaffinic solvents, lubricants, for example, lube oil blending components and lube oil base stocks suitable for transportation vehicles, non-toxic drilling oils suitable for use in drilling muds, technical and medicinal grade white oil, chemical raw materials, and various specialty products.

The gas converter can include a slurry bubble column reactor to produce a Fischer-Tropsch product. The slurry bubble column reactor can operate at a temperature of less than about 220° C. and from about 69 kPa to about 4,137 kPa, or about 1,724 kPa to about 2,413 kPa using a cobalt catalyst promoted with rhenium and supported on titania having a Re:Co weight ratio in a range of about 0.01 to about 1 and containing from about 2% wt to about 50% wt cobalt. The catalyst within the slurry bubble column reactor can include, but is not limited to, a titania support impregnated with a salt of a catalytic copper or an Iron Group metal, a polyol or polyhydric alcohol and, optionally, a rhenium compound or salt. Examples of suitable polyols or polyhydric alcohols include, but are not limited to, glycol, glycerol, derythritol, threitol, ribitol, arabinitol, xylitol, allitol, dulcitol, gluciotol, sorbitol, and mannitol. The catalytic metal, copper or Iron Group metal as a concentrated aqueous salt solution, for example cobalt nitrate or cobalt acetate, can be combined with the polyol and optionally perrhenic acid while adjusting the amount of water to obtain 15 wt % metal, for example, 15 wt % cobalt, in the solution and using optionally incipient wetness techniques to impregnate the catalyst onto rutile or anatase titania support, optionally spray-dried and calcined. This method reduces the need for rhenium promoter.

The gas converter can be used to produce methanol, alkyl formates, dimethyl ether, ammonia, acetic anhydride, acetic acid, methyl acetate, acetate esters, vinyl acetate and polymers, ketenes, formaldehyde, dimethyl ether, olefins, derivatives thereof, and/or combinations thereof. For methanol production, for example, the Liquid Phase Methanol Process can be used (LPMEOH™). In this process, the carbon monoxide in the syngas can be directly converted into methanol using a slurry bubble column reactor and catalyst in an inert hydrocarbon oil reaction medium which can conserve heat of reaction while idling during off-peak periods for a substantial amount of time while maintaining good catalyst activity. Gas phase processes for producing methanol can also be used. For example, known processes using copper-based catalysts can be used. For alkyl formate production, for example, methyl formate, any of several processes wherein carbon monoxide and methanol are reacted in either the liquid or gaseous phase in the presence of an alkaline catalyst or alkali or alkaline earth metal methoxide catalyst can be used. The methanol can be used as produced and/or further processed to provide one or more additional products. Additional products produced from methanol can include, but are not limited to, dimethyl ether (“DME”), formalin, acetic acid, formaldehyde, methyl-tertiary butyl ether, methylamines, methyl methacrylate, dimethyl terephthalate, methyl mercaptan, methyl chloride, methyl acetate, acetic anhydride, ethylene, propylene, polyolefins, derivatives thereof, mixtures thereof, or combinations thereof.

For ammonia production, the gas converter can be adapted to operate known processes to produce ammonia. The ammonia product can be used as produced and/or further processed to provide one or more additional products. Additional products that can be produced, at least in part, from ammonia can include, but are not limited to, urea, ammonium salts, ammonium phosphates, nitric acid, acrylonitrile, and amides.

Carbon dioxide can be separated and/or recovered from the syngas. Physical adsorption techniques can be used. Examples of suitable adsorbents and techniques can include, but are not limited to, propylene carbonate physical adsorbent solvent as well as other alkyl carbonates, dimethyl ethers of polyethylene glycol of two to twelve glycol units (Selexol™ process), n-methyl-pyrrolidone, sulfolane, and use of the Sulfinol® Gas Treatment Process.

At least a portion of the syngas can be sold or upgraded using further downstream processes. At least a portion of the syngas can be directed to a hydrogen separator. At least a portion of the syngas can bypass the gas converter described above and can be fed directly to the hydrogen separator.

The hydrogen separator can include any system or device to selectively separate hydrogen from syngas to provide a purified hydrogen stream and a waste gas stream. The hydrogen separator can provide a carbon dioxide rich fluid and a hydrogen rich fluid. At least a portion of the hydrogen rich fluid can be used as a feed to a fuel cell and at least a portion of the hydrogen rich fluid can be combined with the syngas prior to use as a fuel in a combustor. The hydrogen separator can utilize pressure swing absorption, cryogenic distillation, and/or semi-permeable membranes. Examples of suitable absorbents include, but are not limited to, caustic soda, potassium carbonate or other inorganic bases, and/or alanolamines.

At least a portion of the syngas can be combusted in a combustor to provide a high pressure/high temperature exhaust gas stream. The high pressure/high temperature exhaust gas stream can be introduced to a combustion turbine to provide an exhaust gas stream and mechanical shaft power to drive an electric generator. The exhaust gas stream can be introduced to a heat recovery system to provide steam. A first portion of the steam can be introduced to a steam turbine to provide mechanical shaft power to drive an electric generator. A second portion of the steam can be introduced to the gasifier, and/or other auxiliary process equipment. Lower pressure steam from the steam turbine can be recycled to the heat recovery system.

Oxygen enriched air or essentially oxygen from one or more air separation units (“ASU”) can be supplied to the gasifier. The ASU can provide a nitrogen-lean and oxygen-rich stream to the gasifier, thereby minimizing the nitrogen concentration in the system. The use of a nearly pure oxygen stream allows the gasifier to produce a syngas that is essentially nitrogen-free, for example, containing less than 0.5% nitrogen/argon. The ASU can be a high-pressure, cryogenic type separator that can be supplemented with air. A reject nitrogen stream from the ASU can be added to a combustion turbine or used as utility. For example, up to about 50 vol %, or up to about 40 vol %, or up to about 30 vol %, or up to about 20 vol %, or up to about 10 vol % of the total oxidant fed to the gasifier can be supplied by the ASU.

Illustrative systems and methods for further processing at least a portion of the syngas can be as discussed and described in U.S. Pat. Nos. 7,932,296; 7,722,690; 7,687,041; and 7,138,001 and U.S. Patent Application Publication Nos.: 2009/0294328; 2009/0261017; 2009/0151250; and 2009/0064582.

With reference to the FIGURE, an illustrative gasification system 100 is depicted for gasifying one or more hydrocarbon feedstocks, according to one or more embodiments. The gasification system 100 can include a single gasifier or two or more gasifiers arranged in series and/or parallel (one is shown 102). One or more oxidants (three are shown via lines 128, 144, and 148) and one or more hydrocarbon materials or feedstocks (two are shown via lines 130 and 146) can be introduced to the gasifier 102. Introduction of the one or more oxidants via lines 128, 144, and/or 148 and the one or more hydrocarbon feedstocks via lines 130 and/or 146 can be interspersed along a length of the gasifier 102 with respect to one another. The interspersion of the oxidants via lines 128, 144, and/or 148 and the hydrocarbon feedstocks via lines 130 and/or 146 can be alternating with respect to one another.

The gasification system 100 can also include one or more start-up heaters (one is shown 104). The start-up heater 104 can combust and/or heat one or more start-up fuels and/or inert mediums to provide a start-up combustion gas and/or an inert medium via line 106 that can assist in the start-up of the gasifier 102. It should be noted that the start-up combustion gas and/or the inert medium via line 106 can be introduced to one or more locations within the gasifier 102 via line 106 and/or via a plurality of lines 106.

Each gasifier 102 can include one or more first mixing zones 108, one or more second mixing zones 110, one or more risers or gasification zones 112, one or more disengagers or separators (two are shown 114 and 116), one or more standpipes 118, and one or more transfer lines (four are shown 120, 122, 124, and 126). Although not shown, one or more of the transfer lines 120, 122, 124, and 126 can include one or more flow control devices such as valves for controlling the flow of fluids and/or circulating particulates 132 therethrough. Illustrative control devices can include, but are not limited to, “j-valves,” “y-valves,” “L-valves,” or any combination thereof. If the gasification system 100 includes two or more gasifiers 102, each gasifier 102 can be configured independent from the others or configured where any of the one or more mixing zones 108, 110; gasification zones 112; separators 114, 116; and/or standpipes 118 can be shared. For simplicity and ease of description, embodiments of the gasifier 102 will be further described in the context of a single reactor train.

The first oxidant via line 128 and the start-up combustion gas and/or the heat-up gas via line 106 (if used, e.g., during start-up and/or heat-up of the gasifier 102) can be introduced to the first mixing zone 108 and can flow from the first mixing zone 108 and into the second mixing zone 110. The first hydrocarbon feedstock via line 130 can be introduced to the second mixing zone 110. The circulating particulates 132 via transfer line 126 can be introduced to the first mixing zone 108, the second mixing zone 110, and/or, as shown, between the first mixing zone 108 and the second mixing zone 110. At least a portion of the first hydrocarbon feedstock and/or at least a portion of any carbonaceous material deposited on the circulating particulates 132 can be combusted, vaporized, cracked, and/or gasified to produce a fluid/particulate mixture, e.g., a first heat, a first combustion gas, vaporized hydrocarbons, cracked hydrocarbons, and/or syngas within the second mixing zone 110.

The vaporization, cracking, and/or gasification of the first hydrocarbon feedstock and/or the carbonaceous material deposited on the circulating particulates 132 as well as the particulates themselves can absorb at least a portion of the heat produced by combusting the at least a portion of the first hydrocarbon feedstock and/or the at least a portion of any carbonaceous material deposited on the circulating particulates 132. The amount of oxidant introduced via line 128 to the first mixing zone 108 can be based, at least in part, on the amount of the first hydrocarbon feedstock introduced via line 130 and/or the amount of any carbon and/or carbonaceous material deposited on the circulating particulates 132. Controlling the amount of oxidant via line 128 relative to the amount of carbonaceous material introduced via transfer line 126 and/or line 130 can be used to control the temperature within the second mixing zone 110. In other words, the temperature increase caused by combusting the carbonaceous material can be controlled or moderated by controlling the amount of oxidant introduced via line 128. The resulting fluid/particulate mixture, e.g., first heat, first combustion gas, vaporized hydrocarbons, cracked hydrocarbons, and/or syngas, can flow through the second mixing zone 110 toward the gasification zone 112.

The first oxidant via line 128 to the first mixing zone 108, the first hydrocarbon feedstock via line 130 to the second mixing zone 110, and/or the particulates 132 that can contain carbonaceous material deposited thereon introduced to the second mixing zone 110, can produce a first heat and a first temperature of one or more of the circulating particulates 132 within the second mixing zone 110. In other words, combustion of at least a portion of the carbonaceous material contained in the first hydrocarbon feedstock via line 130 and/or deposited on the particulates 132 can produce a first heat and one or more of the circulating particulates 132 at a first temperature. At least a portion of the first heat can be absorbed by the vaporization, cracking, and/or gasification of volatile components and/or by the initiation of the gasification of the first hydrocarbon feedstock to help decrease the first temperature of one or more of the circulating particulates 132 in the second mixing zone 110. The first temperature of one or more of the circulating particulates 132 within the second mixing zone 110 can range as discussed and described herein.

The second oxidant via line 144 can be introduced to the second mixing zone 110 downstream of the first hydrocarbon feedstock introduced via line 130. In one or more embodiments, the second hydrocarbon feedstock via line 146 can be introduced to the second mixing zone 110 downstream of the second oxidant introduced via line 144. In the presence of the second oxidant introduced via line 144, at least a portion of the first hydrocarbon feedstock introduced via line 130, any carbonaceous material deposited on the circulating particulates 132, and/or at least a portion of the second hydrocarbon feedstock introduced via line 146 can be combusted, vaporized, cracked, and/or gasified within the second mixing zone 110 to produce a fluid/particulate mixture, e.g., a second heat, a second combustion gas, vaporized hydrocarbons, cracked hydrocarbons, and/or syngas. Similar to the reactions that can occur with the first hydrocarbon feedstock and/or the circulating particulates 132, with or without carbonaceous material deposited thereon, the second hydrocarbon feedstock introduced via line 146 can also absorb at least a portion of the heat produced by combusting at least a portion of the first hydrocarbon feedstock, at least a portion of the second hydrocarbon feedstock, and/or any carbonaceous material deposited and/or remaining on the circulating particulates 132. As such, the amount of the second oxidant introduced via line 144 can be based, at least in part, on the amount of the second hydrocarbon feedstock introduced via line 146, the amount of any carbonaceous material deposited on the circulating particulates 132, and/or the amount of the first hydrocarbon feedstock introduced via line 130. Controlling the amount of the second oxidant via line 144 relative to the amount of carbonaceous material within the second mixing zone 110 can be used to control the temperature within the second mixing zone 110. In other words, the temperature increase caused by combusting the second hydrocarbon feedstock, any carbonaceous material deposited on the circulating particulates 132, and/or the first hydrocarbon feedstock can be controlled or moderated by controlling the amount of second oxidant introduced via line 144.

The second oxidant introduced via line 144 to the second mixing zone 110 can provide for an increase in the first temperature of one or more of the circulating particulates 132 within the second mixing zone 110 to produce a second temperature of one or more of the circulating particulates 132. Combustion of at least a portion of the first hydrocarbon feedstock and/or any carbonaceous material deposited on the circulating particulates 132 utilizing the second oxidant introduced via line 144 can produce the second heat and can cause the increase in the first temperature of one or more of the circulating particulates 132 to produce one or more of the circulating particulates 132 at the second temperature. The second temperature of one or more of the circulating particulates 132 within the second mixing zone 110 can range as discussed and described herein.

In one or more embodiments, the second hydrocarbon feedstock introduced via line 146 to the second mixing zone 110 can produce a third temperature of one or more of the circulating particulates 132 within the second mixing zone 110. At least a portion of the heat of combustion can be absorbed by the vaporization and/or cracking of volatile components, by the continuation of the gasification of the first hydrocarbon feedstock, by the initiation of the gasification of the second hydrocarbon feedstock, or a combination thereof to decrease the third temperature of one or more of the circulating particulates 132 within the second mixing zone 110. The third temperature of one or more of the circulating particulates 132 within the second mixing zone 110 can range as discussed and described herein.

In one or more embodiments, the third oxidant via line 148 can be introduced to the second mixing zone 110 and/or the gasification zone 112 downstream from the second oxidant introduced via line 144 and/or the second hydrocarbon feedstock introduced via line 146. Introduction of the third oxidant via line 148 can be used to control or adjust the heat of the fluid/particulate mixture flowing toward and/or within the gasification zone 112. For example, if more heat is desired for carrying out the additional reactions, e.g., vaporization, cracking, and/or gasification of any remaining volatile components and/or hydrocarbon feedstock, within the gasification zone 112, the amount of the third oxidant via line 148 can be increased. In another example, if less heat is desired for carrying out the additional reactions within the gasification zone 112, the amount of the third oxidant via line 148 can be decreased or completely stopped. As such, the third oxidant via line 148 can be referred to as a “trim” oxidant because the third oxidant via line 148 can be used to adjust the temperature or amount of heat introduced to the gasification zone 112 via the fluid/particulate mixture flowing into the gasification zone 112 from the second mixing zone 110.

Introducing the third oxidant via line 148 to the second mixing zone 110 and/or the gasification zone 112 can be used to produce and adjust a fourth temperature of one or more of the circulating particulates 132 within the second mixing zone 110 and/or the gasification zone 112. For example, increasing the amount of the third oxidant via line 148 to the second mixing zone 110 and/or the gasification zone 112 can help to increase the fourth temperature of one or more of the circulating particulates 132 in the second mixing zone 110 and/or the gasification zone 112. In another example, decreasing the amount of the third oxidant via line 148 to the second mixing zone 110 and/or the gasification zone 112 can help to decrease the fourth temperature of one or more of the circulating particulates 132 in the second mixing zone 110 and/or the gasification zone 112. Thus, introducing the third oxidant via line 148 to the second mixing zone 110 and/or the gasification zone 112 can help provide for an adjusting or tuning of the fourth temperature of one or more of the circulating particulates 132 in the second mixing zone 110 and/or the gasification zone 112. The fourth temperature of one or more of the circulating particulates 132 within the second mixing zone 110 and/or the gasification zone 112 can range as discussed and described herein.

The primary reactions that can take place within the riser or gasification zone 112 can be vaporization, cracking, and/or gasification of any remaining carbonaceous materials introduced via lines 130, 146, and/or the carbonaceous material containing particulates 132. Additionally, carbonaceous material, e.g., carbon, from the first and/or second hydrocarbon feedstocks introduced via lines 130 and 146, respectively, can be deposited onto the particulates within the second mixing zone 110 to provide particulates 132 having carbonaceous material deposited thereon. As discussed in more detail below, the circulating particulates 132 having carbonaceous material deposited thereon can be recirculated or recycled via transfer line 126 to the first mixing zone 108, the second mixing zone 110, and/or the gasification zone 112, e.g., in sequence, and/or between the first and second mixing zones 108, 110.

The temperature within the gasification zone 112 can be sufficient to gasify at least a portion of any remaining first hydrocarbon feedstock via line 130, second hydrocarbon feedstock via line 146, and/or carbonaceous material deposited on the circulating particulates 132 to produce a fluid/particulate mixture or “syngas.” For example, the temperature within the gasification zone 112 can be sufficient to gasify all of the remaining first hydrocarbon feedstock, second hydrocarbon feedstock, and/or carbonaceous material deposited on the circulating particulates 132. In another example, the temperature within the gasification zone 112 can be sufficient to gasify, crack, vaporize, and/or deposit the carbonaceous material introduced thereto in the form of the first hydrocarbon feedstock via line 130 and/or the second hydrocarbon feedstock via line 146 and/or as carbonaceous material deposited on the circulating particulates 132. The temperature within the gasification zone 112 can range as discussed and described herein.

The fluid/particulate mixture or syngas produced within the first mixing zone 108, the second mixing zone 110, and/or the gasification zone 112 can be introduced via transfer line 120 to the first separator 114 where at least a portion of the particulates 132 can be separated therefrom to provide a first separated syngas via transfer line 122 and separated particulates 132 via transfer line 124. All or a portion of the separated particulates 132 via transfer line 124 can be introduced to the standpipe 118. All or a portion of the separated particulates 132 in transfer line 124 can be removed from the gasifier 102 via line 134. Removing particulates 132 via line 134 from the gasifier 102 can be used to control the height of particulates within the standpipe 118 and/or the total amount of particulates circulating within the gasifier 102. The first separated gas via transfer line 122 can be introduced to the second separator 116 where a second portion, if any, of the particulates 132 can be separated therefrom to produce a separated gas product or a separated syngas via line 136 and separated particulates that can be introduced to the standpipe 118. The separators 114 and 116 can be or include any device, system, or combination of devices and/or systems capable of separating or removing at least a portion of the particulates 132 from the fluid/particulate mixture. Illustrative separators can include, but are not limited to, cyclones, desalters, and/or decanters.

As discussed above, the particulates 132 that can include carbonaceous material deposited thereon can be recycled via the transfer or “recycle” line 126 from the standpipe 118 to the first mixing zone 108, the second mixing zone 110, and/or between the first and second mixing zones 108, 110. The particulates 132 can be loaded or otherwise disposed within the gasifier 102 prior to introducing the start-up combustion gas and/or the inert medium via line 106 to gasifier 102 when the start-up heater 104 is utilized to start-up and/or heat-up the gasifier 102 or operation of the gasifier 102 is otherwise initiated. As such, circulation of particulates 132 can begin prior to introducing the start-up combustion gas and/or the inert medium via line 106 to the first mixing zone 108. One or more fluids via one or more fluid introduction lines (three are shown 138, 140, and 142) can be introduced to the transfer line 124, the standpipe 118, and the recycle line 126, respectively, in order to provide a motive fluid within the gasifier 102 for circulating the particulates 132 within the gasifier 102. Illustrative fluids introduced via lines 138, 140, and/or 142 can include, but are not limited to, inert gases such as nitrogen, combustible gases such as recycled syngas, mixtures thereof, carbon dioxide, or any combination thereof.

As shown, the first hydrocarbon feedstock via line 130 and the second hydrocarbon feedstock via line 146 can be introduced to the second mixing zone 110. In another example, the first hydrocarbon feedstock via line 130 and/or the second hydrocarbon feedstock via line 146 can be introduced to the first mixing zone 108, the second mixing zone 110, the gasification zone 112, and/or the transfer line 120.

The first oxidant via line 128, the second oxidant via line 144, the third oxidant via line 148, the first hydrocarbon feedstock via line 130, and/or the second hydrocarbon feedstock via line 146 can be introduced to the gasifier 102 continuously, intermittently, simultaneously, separately, sequentially, or a combination thereof.

Although not shown, one or more valves or other flow restricting devices can be used to control or adjust the amount of oxidant in lines 128, 144, and 148, the start-up combustion gas and/or the inert medium in line 106, the first hydrocarbon feedstock in line 130, the second hydrocarbon feedstock in line 146, the hot gas product or syngas in line 136, the fluids in lines 138, 140, and 142, and/or the particulates in line 134.

In one or more embodiments, the first oxidant via line 128, the second oxidant via line 144, and the third oxidant via line 148 can be the same or different with respect to one another. In one or more embodiments, the first hydrocarbon feedstock via line 130 and the second hydrocarbon feedstock via line 146 can be the same or different with respect to one another. In one or more embodiments, the first oxidant via line 128, the second oxidant via line 144, the third oxidant via line 148, the first hydrocarbon feedstock via line 130, and/or the second hydrocarbon feedstock via line 146 can be introduced to the gasifier 102 from a source and/or location external to the gasifier 102.

Embodiments described herein further relate to any one or more of the following paragraphs:

1. A method for controlling the gasification of one or more hydrocarbon feedstocks, comprising: introducing a first oxidant to a gasifier; introducing a first hydrocarbon feedstock to the gasifier downstream of the first oxidant; introducing a second oxidant to the gasifier downstream of the first oxidant and the first hydrocarbon feedstock, wherein the second oxidant is introduced from a location that is external to the gasifier; and gasifying at least a portion of the first hydrocarbon feedstock to produce a syngas.

2. The method of paragraph 1, further comprising introducing a second hydrocarbon feedstock to the gasifier downstream of the second oxidant.

3. The method of paragraph 1 or 2, further comprising introducing a third oxidant to the gasifier downstream of the second oxidant, wherein the third oxidant is introduced from a location that is external to the gasifier.

4. The method according to any one of paragraphs 1 to 3, further comprising introducing a second hydrocarbon feedstock downstream of the second oxidant, and introducing a third oxidant downstream of the second hydrocarbon feedstock, wherein the third oxidant is introduced from a location that is external to the gasifier.

5. The method according to any one of paragraphs 1 to 4, further comprising circulating particulates through the gasifier, wherein the circulating particulates comprise sand, ash, ceramic, limestone, or any combination thereof.

6. The method according to any one of paragraphs 1 to 5, further comprising circulating particulates through the gasifier, and wherein the introducing a first hydrocarbon feedstock produces a first temperature of one or more of the circulating particulates ranging from about 700° C. to about 1,000° C. and wherein the introducing a second oxidant produces a second temperature of one or more of the circulating particulates ranging from about 700° C. to about 1,000° C.

7. The method according to any one of paragraphs 1 to 6, wherein the difference between the first temperature and the second temperature is less than about 150° C., with respect to one another.

8. The method according to any one of paragraphs 1 to 7, further comprising circulating particulates through the gasifier, wherein the introducing a first hydrocarbon feedstock produces a first temperature of one or more of the circulating particulates ranging from about 700° C. to about 1,000° C., wherein the introducing a second oxidant produces a second temperature of one or more of the circulating particulates ranging from about 700° C. to about 1,000° C., wherein the introducing a second hydrocarbon feedstock produces a third temperature of one or more of the circulating particulates ranging from about 700° C. to about 1,000° C., and wherein the introducing a third oxidant produces a fourth temperature of one or more of the circulating particulates ranging from about 700° C. to about 1,000° C.

9. The method according to any one of paragraphs 1 to 8, wherein the difference between the first temperature, the second temperature, the third temperature, and the fourth temperature is less than about 150° C., with respect to one another.

10. A method for controlling the gasification of one or more hydrocarbon feedstocks, comprising: introducing a first oxidant to a first mixing zone of a gasifier; introducing a first hydrocarbon feedstock to a second mixing zone of the gasifier; combusting at least a portion of the first hydrocarbon feedstock in the presence of the first oxidant to produce a first combustion gas and a first heat; introducing a second oxidant to the second mixing zone downstream of the first hydrocarbon feedstock, wherein the second oxidant is introduced from a location that is external to the gasifier; combusting a second portion of the first hydrocarbon feedstock in the presence of the second oxidant and the first combustion gas to produce a second combustion gas and a second heat; and gasifying at least a portion of the first hydrocarbon feedstock to produce a syngas.

11. The method of paragraph 10, further comprising introducing a second hydrocarbon feedstock to the second mixing zone downstream of the second oxidant, combusting at least a portion of the second hydrocarbon feedstock in the presence of the second oxidant, and gasifying at least a portion of the second hydrocarbon feedstock to produce the syngas.

12. The method of paragraph 10 or 11, further comprising introducing a third oxidant to the second mixing zone downstream of the second oxidant, wherein the third oxidant is introduced from a location that is external to the gasifier.

13. The method according to any one of paragraphs 10 to 12, further comprising introducing a second hydrocarbon feedstock to the second mixing zone downstream of the second oxidant, combusting at least a portion of the second hydrocarbon feedstock in the presence of the second oxidant, gasifying at least a portion of the second hydrocarbon feedstock to produce the syngas, and further comprising introducing a third oxidant to the second mixing zone downstream of the second hydrocarbon feedstock, wherein the third oxidant is introduced from a location that is external to the gasifier.

14. The method according to any one of paragraphs 10 to 13, further comprising circulating particulates through the gasifier and further comprising combusting at least a portion of a carbonaceous material present on the circulating particulates.

15. The method according to any one of paragraphs 10 to 14, further comprising circulating particulates through the gasifier, wherein the introducing a first hydrocarbon feedstock produces a first temperature of one or more of the circulating particulates within the second mixing zone ranging from about 700° C. to about 1,000° C., and wherein the introducing a second oxidant produces a second temperature of one or more of the circulating particulates within the second mixing zone ranging from about 700° C. to about 1,000° C., and wherein the difference between the first temperature and the second temperature is less than about 150° C., with respect to one another.

16. The method according to any one of paragraphs 10 to 15, further comprising circulating particulates through the gasifier, wherein the introducing a first hydrocarbon feedstock produces a first temperature of one or more of the circulating particulates within the second mixing zone ranging from about 700° C. to about 1,000° C., wherein the introducing a second oxidant produces a second temperature of one or more of the circulating particulates within the second mixing zone ranging from about 700° C. to about 1,000° C., wherein the introducing a second hydrocarbon feedstock produces a third temperature of one or more of the circulating particulates within the second mixing zone ranging from about 700° C. to about 1,000° C., and wherein the introducing a third oxidant produces a fourth temperature of one or more of the circulating particulates within the second mixing zone ranging from about 700° C. to about 1,000° C.

17. The method according to any one of paragraphs 10 to 16, wherein the difference between the first temperature, the second temperature, the third temperature, and the fourth temperature is less than about 150° C., with respect to one another.

18. A system for controlling the gasification of one or more hydrocarbon feedstocks, comprising: a gasifier; a first oxidant line for introducing a first oxidant to a first mixing zone of the gasifier; a first hydrocarbon feedstock line for introducing a first hydrocarbon feedstock to a second mixing zone of the gasifier; and a second oxidant line for introducing a second oxidant to the second mixing zone of the gasifier, wherein the second oxidant line is in fluid communication with the gasifier downstream of the first hydrocarbon feedstock line.

19. The system of paragraph 18, further comprising a second hydrocarbon feedstock line for introducing a second hydrocarbon feedstock to the second mixing zone, wherein the second hydrocarbon feedstock line is in fluid communication with the gasifier downstream of the second oxidant line.

20. The system of paragraph 18 or 19, further comprising a third oxidant line for introducing a third oxidant to the second mixing zone of the gasifier, wherein the third oxidant line is in fluid communication with the gasifier downstream of the second oxidant line.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A method for controlling the gasification of one or more hydrocarbon feedstocks, comprising:
introducing a first oxidant to a gasifier;
introducing a first hydrocarbon feedstock to the gasifier downstream of the first oxidant;
introducing a second oxidant to the gasifier downstream of the first oxidant and the first hydrocarbon feedstock, wherein the second oxidant is introduced from a location that is external to the gasifier; and
gasifying at least a portion of the first hydrocarbon feedstock to produce a syngas.

2. The method of claim 1, further comprising introducing a second hydrocarbon feedstock to the gasifier downstream of the second oxidant.

3. The method of claim 1, further comprising introducing a third oxidant to the gasifier downstream of the second oxidant, wherein the third oxidant is introduced from a location that is external to the gasifier.

4. The method of claim 1, further comprising introducing a second hydrocarbon feedstock downstream of the second oxidant, and introducing a third oxidant downstream of the second hydrocarbon feedstock, wherein the third oxidant is introduced from a location that is external to the gasifier.

5. The method of claim 1, further comprising circulating particulates through the gasifier, wherein the circulating particulates comprise sand, ash, ceramic, limestone, or any combination thereof.

6. The method of claim 1, further comprising circulating particulates through the gasifier, and wherein the introducing a first hydrocarbon feedstock produces a first temperature of one or more of the circulating particulates ranging from about 700° C. to about 1,000° C. and wherein the introducing a second oxidant produces a second temperature of one or more of the circulating particulates ranging from about 700° C. to about 1,000° C.

7. The method of claim 6, wherein the difference between the first temperature and the second temperature is less than about 150° C., with respect to one another.

8. The method of claim 4, further comprising circulating particulates through the gasifier, wherein the introducing a first hydrocarbon feedstock produces a first temperature of one or more of the circulating particulates ranging from about 700° C. to about 1,000° C., wherein the introducing a second oxidant produces a second temperature of one or more of the circulating particulates ranging from about 700° C. to about 1,000° C., wherein the introducing a second hydrocarbon feedstock produces a third temperature of one or more of the circulating particulates ranging from about 700° C. to about 1,000° C., and wherein the introducing a third oxidant produces a fourth temperature of one or more of the circulating particulates ranging from about 700° C. to about 1,000° C.

9. The method of claim 8, wherein the difference between the first temperature, the second temperature, the third temperature, and the fourth temperature is less than about 150° C., with respect to one another.

10. A method for controlling the gasification of one or more hydrocarbon feedstocks, comprising:
introducing a first oxidant to a first mixing zone of a gasifier;
introducing a first hydrocarbon feedstock to a second mixing zone of the gasifier;
combusting at least a portion of the first hydrocarbon feedstock in the presence of the first oxidant to produce a first combustion gas and a first heat;
introducing a second oxidant to the second mixing zone downstream of the first hydrocarbon feedstock, wherein the second oxidant is introduced from a location that is external to the gasifier;
combusting a second portion of the first hydrocarbon feedstock in the presence of the second oxidant and the first combustion gas to produce a second combustion gas and a second heat; and
gasifying at least a portion of the first hydrocarbon feedstock to produce a syngas.

11. The method of claim 10, further comprising introducing a second hydrocarbon feedstock to the second mixing zone downstream of the second oxidant, combusting at least a portion of the second hydrocarbon feedstock in the presence of the second oxidant, and gasifying at least a portion of the second hydrocarbon feedstock to produce the syngas.

12. The method of claim 10, further comprising introducing a third oxidant to the second mixing zone downstream of the second oxidant, wherein the third oxidant is introduced from a location that is external to the gasifier.

13. The method of claim 10, further comprising introducing a second hydrocarbon feedstock to the second mixing zone downstream of the second oxidant, combusting at least a portion of the second hydrocarbon feedstock in the presence of the second oxidant, gasifying at least a portion of the second hydrocarbon feedstock to produce the syngas, and further comprising introducing a third oxidant to the second mixing zone downstream of the second hydrocarbon feedstock, wherein the third oxidant is introduced from a location that is external to the gasifier.

14. The method of claim 10, further comprising circulating particulates through the gasifier and further comprising combusting at least a portion of a carbonaceous material present on the circulating particulates.

15. The method of claim 10, further comprising circulating particulates through the gasifier, wherein the introducing a first hydrocarbon feedstock produces a first temperature of one or more of the circulating particulates within the second mixing zone ranging from about 700° C. to about 1,000° C., and wherein the introducing a second oxidant produces a second temperature of one or more of the circulating particulates within the second mixing zone ranging from about 700° C. to about 1,000° C., and wherein the difference between the first temperature and the second temperature is less than about 150° C., with respect to one another.

16. The method of claim 13, further comprising circulating particulates through the gasifier, wherein the introducing a first hydrocarbon feedstock produces a first temperature of one or more of the circulating particulates within the second mixing zone ranging from about 700° C. to about 1,000° C., wherein the introducing a second oxidant produces a second temperature of one or more of the circulating particulates within the second mixing zone ranging from about 700° C. to about 1,000° C., wherein the introducing a second hydrocarbon feedstock produces a third temperature of one or more of the circulating particulates within the second mixing zone ranging from about 700° C. to about 1,000° C., and wherein the introducing a third oxidant produces a fourth temperature of one or more of the circulating particulates within the second mixing zone ranging from about 700° C. to about 1,000° C.

17. The method of claim 16, wherein the difference between the first temperature, the second temperature, the third temperature, and the fourth temperature is less than about 150° C., with respect to one another.

18. A system for controlling the gasification of one or more hydrocarbon feedstocks, comprising:
a gasifier;
a first oxidant line for introducing a first oxidant to a first mixing zone of the gasifier;
a first hydrocarbon feedstock line for introducing a first hydrocarbon feedstock to a second mixing zone of the gasifier; and
a second oxidant line for introducing a second oxidant to the second mixing zone of the gasifier, wherein the second oxidant line is in fluid communication with the gasifier downstream of the first hydrocarbon feedstock line.

19. The system of claim 18, further comprising a second hydrocarbon feedstock line for introducing a second hydrocarbon feedstock to the second mixing zone, wherein the second hydrocarbon feedstock line is in fluid communication with the gasifier downstream of the second oxidant line.

20. The system of claim 18, further comprising a third oxidant line for introducing a third oxidant to the second mixing zone of the gasifier, wherein the third oxidant line is in fluid communication with the gasifier downstream of the second oxidant line.
